(19) United States
(12) Patent Application Publication
(10) Pub. No.: US 2024/0143174 A1
(43) Pub. Date: May 2, 2024

(54) SYSTEM AND METHOD FOR MEMORY MANAGEMENT OF MACHINE LEARNING-BASED STORAGE OBJECT PERFORMANCE FORECASTING

(71) Applicant: Del Products, L.P., Round Rock, TX (US)

(72) Inventors: Shaul Dar, Petach Tikva (IL); Ramakanth Kanagovi, Bengaluru (IN); Vamsi Vankamamidi, Hopkinton, MA (US); Guhesh Swaminathan, Tamil Nadu (IN); Shuyu Lee, Acton, MA (US)

(21) Appl. No.: 17/973,636

(22) Filed: Oct. 26, 2022

(51) Int. Cl. G06F 3/06

(52) U.S. Cl. CPC G06F 3/0611; G06F 3/0653; G06F 3/067

(57) ABSTRACT

A method, computer program product, and computing system for determining a respective past activity level associated with a plurality of storage objects. The plurality of storage objects are divided into a plurality of storage object groups based upon, at least in part, the respective past activity level associated with the plurality of storage objects. Input/output (IO) performance data for a first storage object group of the plurality of storage object groups is forecasted using a first machine learning model. IO performance data for a second storage object group of the plurality of storage object groups is forecasted using a statistical method.

### BACKGROUND

The ability to accurately forecast the activity pattern of storage objects such as files, volumes, or extents, in a storage system, can enable significant performance gains. Such forecasting of the general level of activity of the storage object is often referred to as the “temperature” of the storage object, where an active storage object is considered “hot” and an inactive object is considered “cold”. The temperature may be defined in terms of the number of IO operations performed by the storage object in a given time unit, the total number of bytes transferred, or some combination of similar metrics.

Machine-learning (ML) based performance forecasting can forecast the future temperature of storage objects with far greater accuracy (i.e., smaller error) then simple statistical methods, and this can result in much better overall performance (e.g., lower latency). However, this improvement comes with a significant computational cost. In a storage system comprising millions of objects, generating features, building a model (i.e., training), and using it periodically to forecast the temperature of all storage objects (i.e., inference), can have a prohibitive cost, in terms of the memory footprint and CPU overhead.

### SUMMARY OF DISCLOSURE

In one example implementation, a computer-implemented method executed on a computing device may include, but is not limited to, determining a respective past activity level associated with a plurality of storage objects. The plurality of storage objects are divided into a plurality of storage object groups based upon, at least in part, the respective past activity level associated with the plurality of storage objects. Input/output (IO) performance data for a first storage object group of the plurality of storage object groups is forecasted using a first machine learning model. IO performance data for a second storage object group of the plurality of storage object groups is forecasted using a statistical method.

One or more of the following example features may be included. Dividing the plurality of storage objects into a plurality of storage object groups based upon, at least in part, the respective past activity level associated with each of the plurality of storage objects may include dividing the plurality of storage objects into an active group, an intermediate group, and a dormant group. Forecasting IO performance data for the first storage object group of the plurality of storage object groups using the first machine learning model may include forecasting IO performance data for storage objects of the active group using a high cost machine learning model. Forecasting IO performance data for the second storage object group of the plurality of storage object groups using the statistical method may include forecasting IO performance data for storage objects of the dormant group using the statistical method. IO performance data for storage objects of the intermediate group is forecasted using a low cost machine learning model. Dividing the plurality of storage objects into the active group, the intermediate group, and the dormant group may include defining the active group as a predefined percentage of the plurality of storage objects with a highest respective past activity level. Forecasting IO performance data may include forecasting IO temperature for the plurality of storage objects.

In another example implementation, a computer program product resides on a computer readable medium that has a plurality of instructions stored on it. When executed by a processor, the instructions cause the processor to perform operations that may include, but are not limited to, determining a respective past activity level associated with a plurality of storage objects. The plurality of storage objects are divided into a plurality of storage object groups based upon, at least in part, the respective past activity level associated with the plurality of storage objects. Input/output (IO) performance data for a first storage object group of the plurality of storage object groups is forecasted using a first machine learning model. IO performance data for a second storage object group of the plurality of storage object groups is forecasted using a statistical method.

One or more of the following example features may be included. Dividing the plurality of storage objects into a plurality of storage object groups based upon, at least in part, the respective past activity level associated with each of the plurality of storage objects may include dividing the plurality of storage objects into an active group, an intermediate group, and a dormant group. Forecasting IO performance data for the first storage object group of the plurality of storage object groups using the first machine learning model may include forecasting IO performance data for storage objects of the active group using a high cost machine learning model. Forecasting IO performance data for the second storage object group of the plurality of storage object groups using the statistical method may include forecasting IO performance data for storage objects of the dormant group using the statistical method. IO performance data for storage objects of the intermediate group is forecasted using a low cost machine learning model. Dividing the plurality of storage objects into the active group, the intermediate group, and the dormant group may include defining the active group as a predefined percentage of the plurality of storage objects with a highest respective past activity level. Forecasting IO performance data may include forecasting IO temperature for the plurality of storage objects.

In another example implementation, a computing system includes at least one processor and at least one memory architecture coupled with the at least one processor, wherein the at least one processor is configured to determine a respective past activity level associated with a plurality of storage objects. The plurality of storage objects are divided into a plurality of storage object groups based upon, at least in part, the respective past activity level associated with the plurality of storage objects. Input/output (IO) performance data for a first storage object group of the plurality of storage object groups is forecasted using a first machine learning model. IO performance data for a second storage object group of the plurality of storage object groups is forecasted using a statistical method.

One or more of the following example features may be included. Dividing the plurality of storage objects into a plurality of storage object groups based upon, at least in part, the respective past activity level associated with each of the plurality of storage objects may include dividing the plurality of storage objects into an active group, an intermediate group, and a dormant group. Forecasting IO performance data for the first storage object group of the plurality of storage object groups using the first machine learning model may include forecasting IO performance data for storage objects of the active group using a high cost machine learning model. Forecasting IO performance data for the second storage object group of the plurality of storage object groups using the statistical method may include forecasting IO performance data for storage objects of the dormant group using the statistical method. IO performance data for storage objects of the intermediate group is forecasted using a low cost machine learning model. Dividing the plurality of storage objects into the active group, the intermediate group, and the dormant group may include defining the active group as a predefined percentage of the plurality of storage objects with a highest respective past activity level. Forecasting IO performance data may include forecasting IO temperature for the plurality of storage objects.

The details of one or more example implementations are set forth in the accompanying drawings and the description below. Other possible example features and/or possible example advantages will become apparent from the description, the drawings, and the claims. Some implementations may not have those possible example features and/or possible example advantages, and such possible example features and/or possible example advantages may not necessarily be required of some implementations.

### BRIEF DESCRIPTION OF THE DRAWINGS

FIG. 1 is an example diagrammatic view of a storage system and a performance forecasting process coupled to a distributed computing network according to one or more example implementations of the disclosure;

FIG. 2 is an example diagrammatic view of the storage system of FIG. 1 according to one or more example implementations of the disclosure;

FIG. 3 is an example flowchart of performance forecasting process according to one or more example implementations of the disclosure;

FIG. 4 is an example diagrammatic view of the storage system of FIG. 1 according to one or more example implementations of the disclosure;

FIG. 5 is an example diagrammatic view of the performance forecasting process according to one or more example implementations of the disclosure; and

FIG. 6 is an example flowchart of the machine learning model process according to one or more example implementations of the disclosure.

Like reference symbols in the various drawings indicate like elements.

### DETAILED DESCRIPTION

### System Overview:

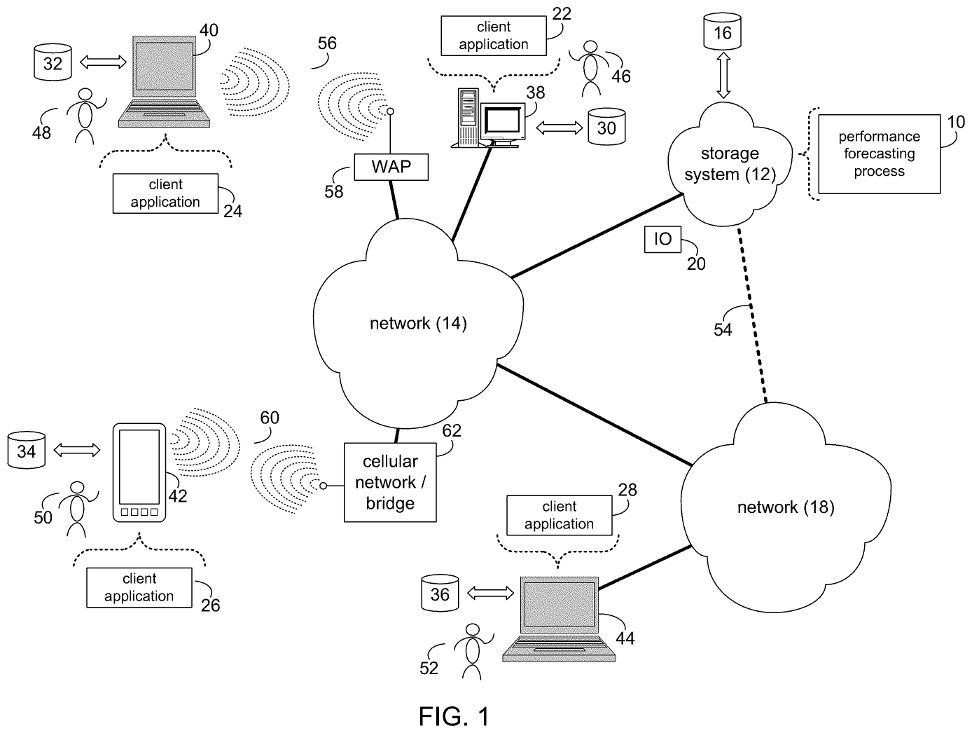

Referring to FIG. 1, there is shown performance forecasting process 10 that may reside on and may be executed by storage system 12, which may be connected to network 14 (e.g., the Internet or a local area network). Examples of storage system 12 may include, but are not limited to: a Network Attached Storage (NAS) system, a Storage Area Network (SAN), a personal computer with a memory system, a server computer with a memory system, and a cloud-based device with a memory system.

As is known in the art, a SAN may include one or more of a personal computer, a server computer, a series of server computers, a mini computer, a mainframe computer, a RAID device and a NAS system. The various components of storage system 12 may execute one or more operating systems, examples of which may include but are not limited to: Microsoft® Windows®; Mac® OS X®; Red Hat® Linux®, Windows® Mobile, Chrome OS, Blackberry OS, Fire OS, or a custom operating system. (Microsoft and Windows are registered trademarks of Microsoft Corporation in the United States, other countries or both; Mac and OS X are registered trademarks of Apple Inc. in the United States, other countries or both; Red Hat is a registered trademark of Red Hat Corporation in the United States, other countries or both; and Linux is a registered trademark of Linus Torvalds in the United States, other countries or both).

The instruction sets and subroutines of performance forecasting process 10, which may be stored on storage device 16 included within storage system 12, may be executed by one or more processors (not shown) and one or more memory architectures (not shown) included within storage system 12. Storage device 16 may include but is not limited to: a hard disk drive; a tape drive; an optical drive; a RAID device; a random access memory (RAM); a read-only memory (ROM); and all forms of flash memory storage devices. Additionally/alternatively, some portions of the instruction sets and subroutines of performance forecasting process 10 may be stored on storage devices (and/or executed by processors and memory architectures) that are external to storage system 12.

Network 14 may be connected to one or more secondary networks (e.g., network 18), examples of which may include but are not limited to: a local area network; a wide area network; or an intranet, for example.

Various IO requests (e.g. IO request 20) may be sent from client applications 22, 24, 26, 28 to storage system 12. Examples of IO request 20 may include but are not limited to data write requests (e.g., a request that content be written to storage system 12) and data read requests (e.g., a request that content be read from storage system 12).

The instruction sets and subroutines of client applications 22, 24, 26, 28, which may be stored on storage devices 30, 32, 34, 36 (respectively) coupled to client electronic devices 38, 40, 42, 44 (respectively), may be executed by one or more processors (not shown) and one or more memory architectures (not shown) incorporated into client electronic devices 38, 40, 42, 44 (respectively). Storage devices 30, 32, 34, 36 may include but are not limited to: hard disk drives; tape drives; optical drives; RAID devices; random access memories (RAM); read-only memories (ROM), and all forms of flash memory storage devices. Examples of client electronic devices 38, 40, 42, 44 may include, but are not limited to, personal computer 38, laptop computer 40, smartphone 42, notebook computer 44, a server (not shown), a data-enabled, cellular telephone (not shown), and a dedicated network device (not shown).

Users 46, 48, 50, 52 may access storage system 12 directly through network 14 or through secondary network 18. Further, storage system 12 may be connected to network 14 through secondary network 18, as illustrated with link line 54.

The various client electronic devices may be directly or indirectly coupled to network 14 (or network 18). For example, personal computer 38 is shown directly coupled to network 14 via a hardwired network connection. Further, notebook computer 44 is shown directly coupled to network 18 via a hardwired network connection. Laptop computer 40 is shown wirelessly coupled to network 14 via wireless communication channel 56 established between laptop computer 40 and wireless access point (e.g., WAP) 58, which is shown directly coupled to network 14. WAP 58 may be, for example, an IEEE 802.11a, 802.11b, 802.11g, 802.11n, Wi-Fi, and/or Bluetooth device that is capable of establishing wireless communication channel 56 between laptop computer 40 and WAP 58. Smartphone 42 is shown wirelessly coupled to network 14 via wireless communication channel 60 established between smartphone 42 and cellular network/bridge 62, which is shown directly coupled to network 14.

Client electronic devices 38, 40, 42, 44 may each execute an operating system, examples of which may include but are not limited to Microsoft® Windows®; Mac® OS X®; Red Hat® Linux®, Windows® Mobile, Chrome OS, Blackberry OS, Fire OS, or a custom operating system. (Microsoft and Windows are registered trademarks of Microsoft Corporation in the United States, other countries or both; Mac and OS X are registered trademarks of Apple Inc. in the United States, other countries or both; Red Hat is a registered trademark of Red Hat Corporation in the United States, other countries or both; and Linux is a registered trademark of Linus Torvalds in the United States, other countries or both).

In some implementations, as will be discussed below in greater detail, a performance forecasting process, such as performance forecasting process 10 of FIG. 1, may include but is not limited to, determining a respective past activity level associated with a plurality of storage objects. The plurality of storage objects are divided into a plurality of storage object groups based upon, at least in part, the respective past activity level associated with the plurality of storage objects. Input/output (IO) performance data for a first storage object group of the plurality of storage object groups is forecasted using a first machine learning model. IO performance data for a second storage object group of the plurality of storage object groups is forecasted using a statistical method.

For example purposes only, storage system 12 will be described as being a network-based storage system that includes a plurality of electro-mechanical backend storage devices. However, this is for example purposes only and is not intended to be a limitation of this disclosure, as other configurations are possible and are considered to be within the scope of this disclosure.

### The Storage System:

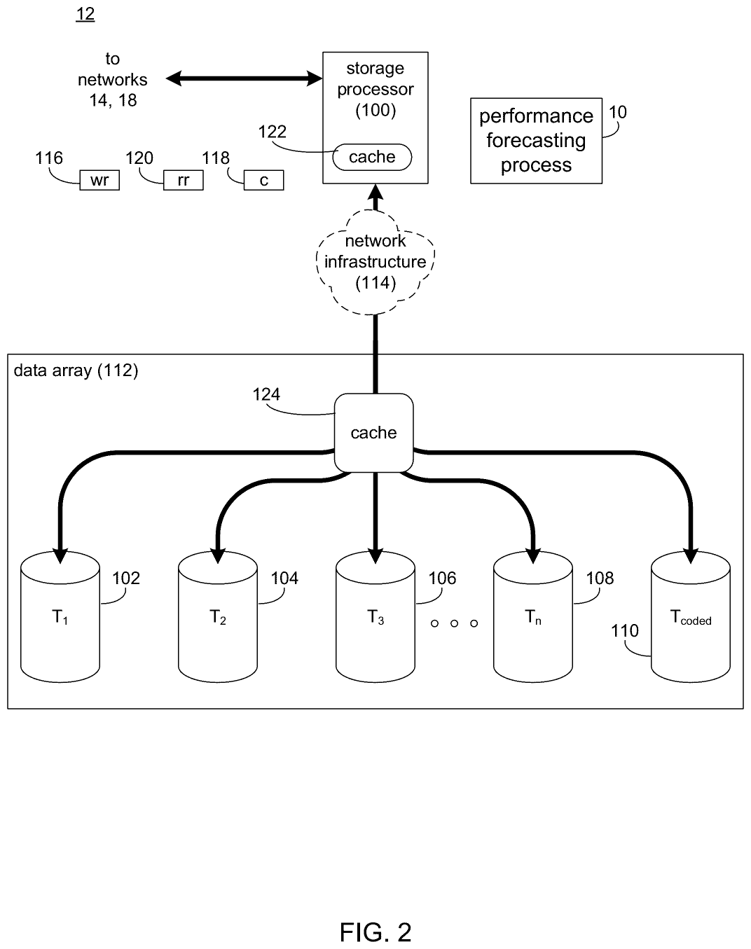

Referring also to FIG. 2, storage system 12 may include storage processor 100 and a plurality of storage targets T 1−n (e.g., storage targets 102, 104, 106, 108). Storage targets 102, 104, 106, 108 may be configured to provide various levels of performance and/or high availability. For example, one or more of storage targets 102, 104, 106, 108 may be configured as a RAID 0 array, in which data is striped across storage targets. By striping data across a plurality of storage targets, improved performance may be realized. However, RAID 0 arrays do not provide a level of high availability. Accordingly, one or more of storage targets 102, 104, 106, 108 may be configured as a RAID 1 array, in which data is mirrored between storage targets. By mirroring data between storage targets, a level of high availability is achieved as multiple copies of the data are stored within storage system 12.

While storage targets 102, 104, 106, 108 are discussed above as being configured in a RAID 0 or RAID 1 array, this is for example purposes only and is not intended to be a limitation of this disclosure, as other configurations are possible. For example, storage targets 102, 104, 106, 108 may be configured as a RAID 3, RAID 4, RAID 5 or RAID 6 array.

While in this particular example, storage system 12 is shown to include four storage targets (e.g. storage targets 102, 104, 106, 108), this is for example purposes only and is not intended to be a limitation of this disclosure. Specifically, the actual number of storage targets may be increased or decreased depending upon e.g., the level of redundancy/performance/capacity required.

Storage system 12 may also include one or more coded targets 110. As is known in the art, a coded target may be used to store coded data that may allow for the regeneration of data lost/corrupted on one or more of storage targets 102, 104, 106, 108. An example of such a coded target may include but is not limited to a hard disk drive that is used to store parity data within a RAID array.

While in this particular example, storage system 12 is shown to include one coded target (e.g., coded target 110), this is for example purposes only and is not intended to be a limitation of this disclosure. Specifically, the actual number of coded targets may be increased or decreased depending upon e.g. the level of redundancy/performance/capacity required.

Examples of storage targets 102, 104, 106, 108 and coded target 110 may include one or more electro-mechanical hard disk drives and/or solid-state/flash devices, wherein a combination of storage targets 102, 104, 106, 108 and coded target 110 and processing/control systems (not shown) may form data array 112.

The manner in which storage system 12 is implemented may vary depending upon e.g. the level of redundancy/performance/capacity required. For example, storage system 12 may be a RAID device in which storage processor 100 is a RAID controller card and storage targets 102, 104, 106, 108 and/or coded target 110 are individual “hot-swappable” hard disk drives. Another example of such a RAID device may include but is not limited to an NAS device. Alternatively, storage system 12 may be configured as a SAN, in which storage processor 100 may be e.g., a server computer and each of storage targets 102, 104, 106, 108 and/or coded target 110 may be a RAID device and/or computer-based hard disk drives. Further still, one or more of storage targets 102, 104, 106, 108 and/or coded target 110 may be a SAN.

In the event that storage system 12 is configured as a SAN, the various components of storage system 12 (e.g. storage processor 100, storage targets 102, 104, 106, 108, and coded target 110) may be coupled using network infrastructure 114, examples of which may include but are not limited to an Ethernet (e.g., Layer 2 or Layer 3) network, a fiber channel network, an InfiniBand network, or any other circuit switched/packet switched network.

Storage system 12 may execute all or a portion of performance forecasting process 10. The instruction sets and subroutines of performance forecasting process 10, which may be stored on a storage device (e.g., storage device 16) coupled to storage processor 100, may be executed by one or more processors (not shown) and one or more memory architectures (not shown) included within storage processor 100. Storage device 16 may include but is not limited to: a hard disk drive; a tape drive; an optical drive; a RAID device; a random access memory (RAM); a read-only memory (ROM); and all forms of flash memory storage devices. As discussed above, some portions of the instruction sets and subroutines of performance forecasting process 10 may be stored on storage devices (and/or executed by processors and memory architectures) that are external to storage system 12.

As discussed above, various IO requests (e.g. IO request 20) may be generated. For example, these IO requests may be sent from client applications 22, 24, 26, 28 to storage system 12. Additionally/alternatively and when storage processor 100 is configured as an application server, these IO requests may be internally generated within storage processor 100. Examples of IO request 20 may include but are not limited to data write request 116 (e.g., a request that content 118 be written to storage system 12) and data read request 120 (i.e. a request that content 118 be read from storage system 12).

During operation of storage processor 100, content 118 to be written to storage system 12 may be processed by storage processor 100. Additionally/alternatively and when storage processor 100 is configured as an application server, content 118 to be written to storage system 12 may be internally generated by storage processor 100.

Storage processor 100 may include frontend cache memory system 122. Examples of frontend cache memory system 122 may include but are not limited to a volatile, solid-state, cache memory system (e.g., a dynamic RAM cache memory system) and/or a non-volatile, solid-state, cache memory system (e.g., a flash-based, cache memory system).

Storage processor 100 may initially store content 118 within frontend cache memory system 122. Depending upon the manner in which frontend cache memory system 122 is configured, storage processor 100 may immediately write content 118 to data array 112 (if frontend cache memory system 122 is configured as a write-through cache) or may subsequently write content 118 to data array 112 (if frontend cache memory system 122 is configured as a write-back cache).

Data array 112 may include backend cache memory system 124. Examples of backend cache memory system 124 may include but are not limited to a volatile, solid-state, cache memory system (e.g., a dynamic RAM cache memory system) and/or a non-volatile, solid-state, cache memory system (e.g., a flash-based, cache memory system). During operation of data array 112, content 118 to be written to data array 112 may be received from storage processor 100. Data array 112 may initially store content 118 within backend cache memory system 124 prior to being stored on e.g. one or more of storage targets 102, 104, 106, 108, and coded target 110.

As discussed above, the instruction sets and subroutines of performance forecasting process 10, which may be stored on storage device 16 included within storage system 12, may be executed by one or more processors (not shown) and one or more memory architectures (not shown) included within storage system 12. Accordingly, in addition to being executed on storage processor 100, some or all of the instruction sets and subroutines of performance forecasting process 10 may be executed by one or more processors (not shown) and one or more memory architectures (not shown) included within data array 112.

Further and as discussed above, during the operation of data array 112, content (e.g., content 118) to be written to data array 112 may be received from storage processor 100 and initially stored within backend cache memory system 124 prior to being stored on e.g. one or more of storage targets 102, 104, 106, 108, 110. Accordingly, during use of data array 112, backend cache memory system 124 may be populated (e.g., warmed) and, therefore, subsequent read requests may be satisfied by backend cache memory system 124 (e.g., if the content requested in the read request is present within backend cache memory system 124), thus avoiding the need to obtain the content from storage targets 102, 104, 106, 108, 110 (which would typically be slower).

### The Performance Forecasting Process:

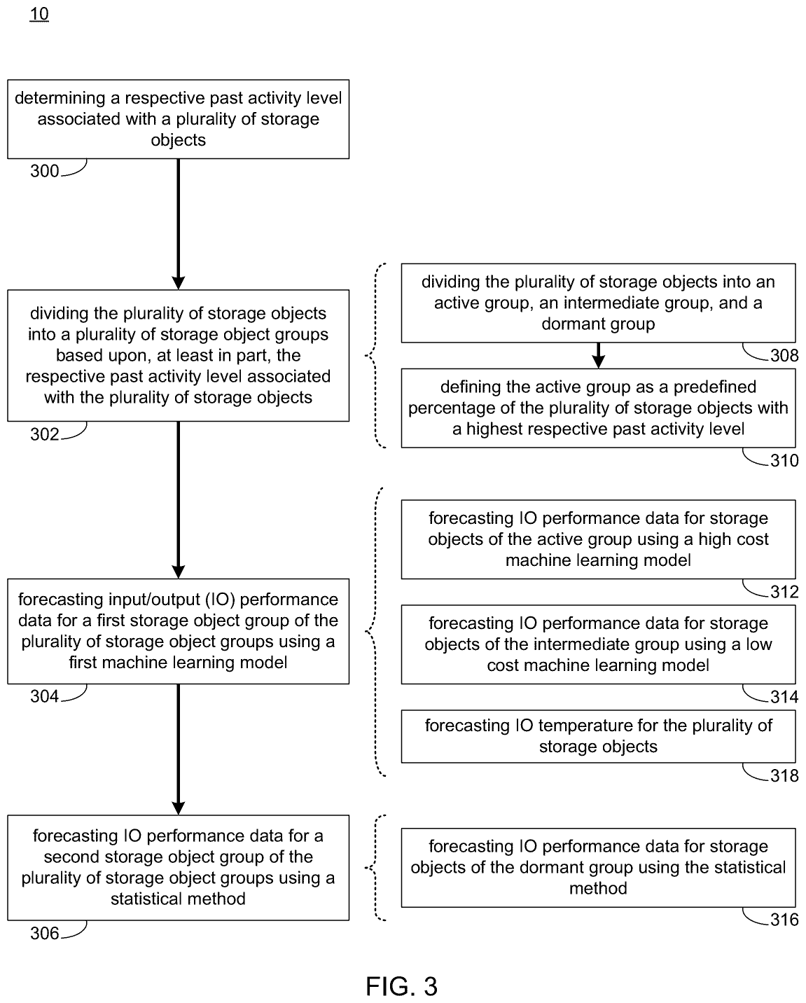

Referring also to the examples of FIGS. 3-6 and in some implementations, performance forecasting process 10 may determine 300 a respective past activity level associated with a plurality of storage objects. The plurality of storage objects are divided 302 into a plurality of storage object groups based upon, at least in part, the respective past activity level associated with the plurality of storage objects. Input/output (IO) performance data for a first storage object group of the plurality of storage object groups is forecasted 304 using a first machine learning model. IO performance data for a second storage object group of the plurality of storage object groups is forecasted 306 using a statistical method.

As will be discussed in greater detail below, implementations of the present disclosure may allow for improved memory management in performance forecasting for a storage system. For example, implementations of the present disclosure use machine learning models selectively to perform performance forecasting for certain storage objects while using statistical models or lower performance machine learning models for other storage objects. In this manner, performance forecasting process 10 consumes orders-of-magnitude fewer resources, while sacrificing very little of the model accuracy. This makes the use of such machine learning methods feasible in storage systems for a variety of use cases.

Consider a typical storage system with a total logical address space of 8EB, and 1PB of physical capacity. Now assume that the storage system is e.g., 50% occupied, (i.e., the total physical occupancy is 500 TB). Assume that the storage objects are 32 MB slices. This means that there are 500 TB/32 MB=16M slices in the system. The amount of RAM required to store the machine learning features for each slice is about 300 bytes. This means that the total feature memory will be about 5 GB. In addition, training the full machine learning model for all slices in the storage system, which may be done once a day, can take hours using 4 CPU cores. Model inference for all slices, which may be done every 15-60 minutes, can take seconds to minutes. As such, the memory footprint and CPU overhead required are prohibitively expensive.

As will be discussed in greater detail below, implementations of the present disclosure divide the total number of storage objects into storage object groups based on their past activity level. For example, while a storage system can have a significant number of storage objects (e.g., slices), only a small number of them are active at any point in time. In a typical storage system, there may be 20 TB of active storage objects or 500,000 slices, which is about 4% of the total occupied capacity. By using different approaches to forecasting IO performance for particular storage objects, the overall efficiency of the storage system may be enhanced.

As will be discussed in greater detail below, implementations of the present disclosure allow for 1) tracking the past level of activity for all storage objects in the system over time; 2) dividing the storage objects into multiple classes according to their past level of activity; 3) calculating a full set of machine learning features and a full or high cost machine learning model for the most active storage objects to forecast their temperature with maximum accuracy; and 4) using simplified statistical methods to forecast the temperature of the less active slices. In some implementations, a combination of models/approaches with increasing levels of complexity and accuracy may be used to get the best trade-off of cost versus benefit. In some implementations, the model training, inference intervals, and the boundaries (e.g., percentage of all storage objects) between the different storage object groups can be adjusted according to the system configuration and the observed level of activity.

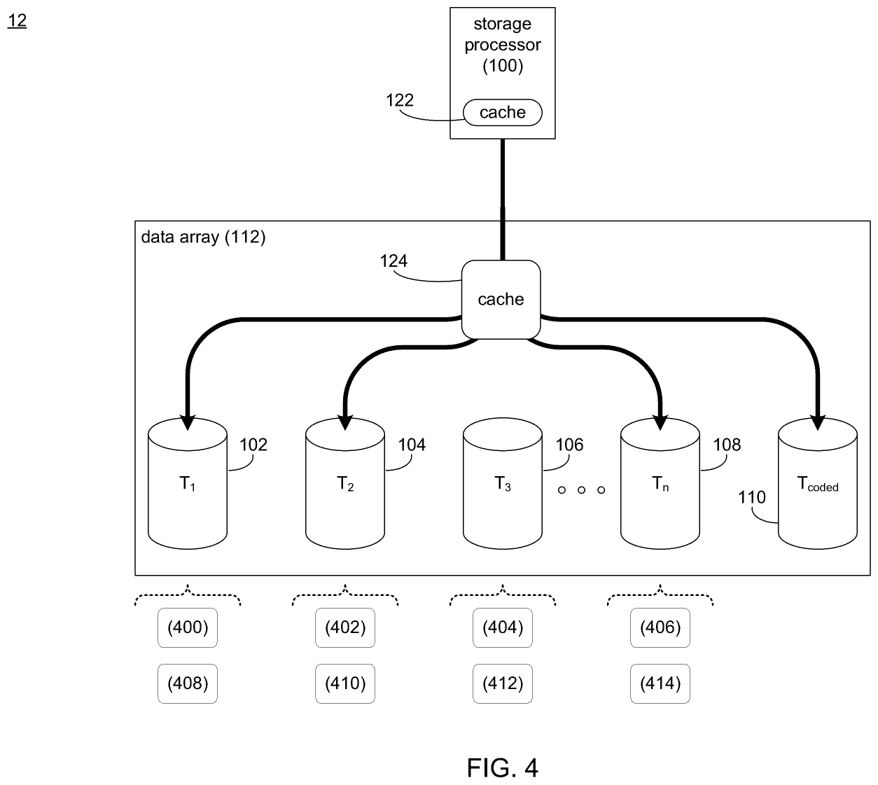

In some implementations, performance forecasting process 10 determines 300 a respective past activity level associated with a plurality of storage objects. For example and referring also to FIG. 4, during the operation of a storage system (e.g., storage system 12), IO operations may be generated for processing data on various storage objects (e.g., storage objects 400, 402, 404, 406, 408, 410, 412, 414). Storage objects (e.g., storage objects 400, 402, 404, 406, 408, 410, 412, 414) may generally include any container or storage unit configured to store data within a storage system (e.g., storage system 12). For example, a storage object may be any one of the following: a volume (aka Logical Unit Number (LUN)), a file, or parts thereof that may be defined e.g. by offsets or address ranges (e.g., sub-LUNs, disk extents, and/or slices). As will be discussed in greater detail below, each storage object may be accessed at different rates under distinct loads than other storage objects during the processing of IO requests.

Performance forecasting process 10 may update IO-related statistics associated with each storage object as IO operations are processed on the storage system. The IO-related statistics may generally include host IO metrics that represent the IO processing performance for a storage system. Examples of IO-related statistics may include, but are not limited to, latency, read input/outputs per second (IOPS), write IOPS, total IOPS, bandwidth, timestamps, hosts, offset in logical address space, length of IO operation, and/or pattern characteristics (e.g., sequential, random, caterpillar, IO-stride, etc.). As will be discussed in greater detail below, IO performance data (e.g., in terms of latency, read IOPS, write IOPS, total IOPS, bandwidth, etc.) may be forecast for storage objects using a high cost or “full” machine learning model for active storage objects and using statistical methods for dormant/inactive storage objects (the least active storage objects).

In some implementations, performance forecasting process 10 determines 300 the respective activity level for a storage object by tracking various IO-related statistics associated with the level of activity for the storage object (e.g., number of IOPS or total bytes transferred). The respective activity level may be defined using e.g., the last five values for the metric(s), and may use their simple or weighted average as the activity level for the storage object. In some implementations, an approximate and relative value is sufficient, and thus a log value, (e.g., may be rounded into a 1-byte small integer), may represent the active level for a storage object for a particular IO-related statistic or for multiple IO-related statistics.

Referring again to FIG. 4, suppose that performance forecasting process 10 determines the respective past activity level for storage objects 400, 402, 404, 406, 408, 410, 412, 414. In this example, suppose that performance forecasting process 10 determines that storage objects 400 and 410 are the most active in terms of their IO-related statistics. Further suppose that storage objects 402 and 404 are less active than storage objects 400 and 410 but are more active than storage objects 406, 408, 412, and 414. In this manner, performance forecasting process 10 may determine the respective past activity level for each storage object and compare the plurality of storage objects using their respective past activity levels to compare them.

In some implementations, performance forecasting process 10 divides 302 the plurality of storage objects into a plurality of storage object groups based upon, at least in part, the respective past activity level associated with the plurality of storage objects. A storage object group is a subset of the plurality of storage objects based upon, at least in part, the respective past activity level associated with each storage object. As will be discussed in greater detail below, performance forecasting process 10 may divide 302 the plurality of storage objects into any number of storage object groups that represent the respective past activity level associated with storage objects. For example, suppose that storage object 400 is accessed in a manner described by a first set of IO-related statistics; storage object 402 is accessed in a manner described by a second set of IO-related statistics; storage object 404 is accessed in a manner described by a third set of IO-related statistics; storage object 406 is accessed in a manner described by a fourth set of IO-related statistics; and so on for each of storage objects 408, 410, 412, and 414. In this example, performance forecasting process 10 may utilize each set of IO-related statistics to divide 302 the plurality of storage objects (e.g., storage objects 400, 402, 404, 406, 408, 410, 412, 414) into a plurality of storage object groups (e.g., storage object groups 500, 502, 504).

In some implementations, dividing 302 the plurality of storage objects into a plurality of storage object groups based upon, at least in part, the respective past activity level associated with each of the plurality of storage objects includes dividing 308 the plurality of storage objects into an active group, an intermediate group, and a dormant group (including the least active storage objects). For example, suppose that storage system 12 is a two-tier system with e.g., 80% hard disk drives (HDDs) and e.g., 20% solid-state drives (SSDs). In this example, performance forecasting process 10 may designate the top e.g., 25% as the active group (adding 5% to cover the “hottest” storage objects that are adjacent to the active group, to allow for transitions between them) and the remaining 75% as the dormant group (e.g., the least active storage objects).

In some implementations, the designations of each storage object group may be based on thresholds. The thresholds may be default thresholds, user-defined thresholds, or dynamically-adjusted thresholds. For example, a dormant storage object group is for any storage object that does not have a least a threshold level of past activity that defines intermediate or active storage objects. An intermediate storage object group is for any storage object that does not have at least a threshold level of past activity that defines an active storage object but more past activity than a threshold defined for dormant storage objects. As will be discussed in greater detail below, performance forecasting process 10 performs IO performance forecasting with different approaches depending on the storage object group. In this manner, the IO performance of the fewer active storage objects is forecast with a more accurate but computationally expensive machine learning model (e.g., high cost machine learning model) while the IO performance of the more numerous dormant storage objects is forecast with a less accurate but computationally efficient statistical method. In this manner, performance forecasting process 10 divides the plurality of storage objects into a two-class grouping.

In another example, performance forecasting process 10 divides 302 the plurality of storage objects into a three-class system. For example, suppose that storage system 12 is a two-tier system with e.g., 80% hard disk drives (HDDs) and e.g., 20% solid-state drives (SSDs). In this example, performance forecasting process 10 designates the top 25% most active storage objects as “hot” in the active group; the next 25% most active as “lukewarm” in the intermediate group; and the remaining 50% as “cold” in the dormant group. In some implementations, the designations of each storage object group may be based on thresholds. The thresholds may be default thresholds, user-defined thresholds, or dynamically-adjusted thresholds.

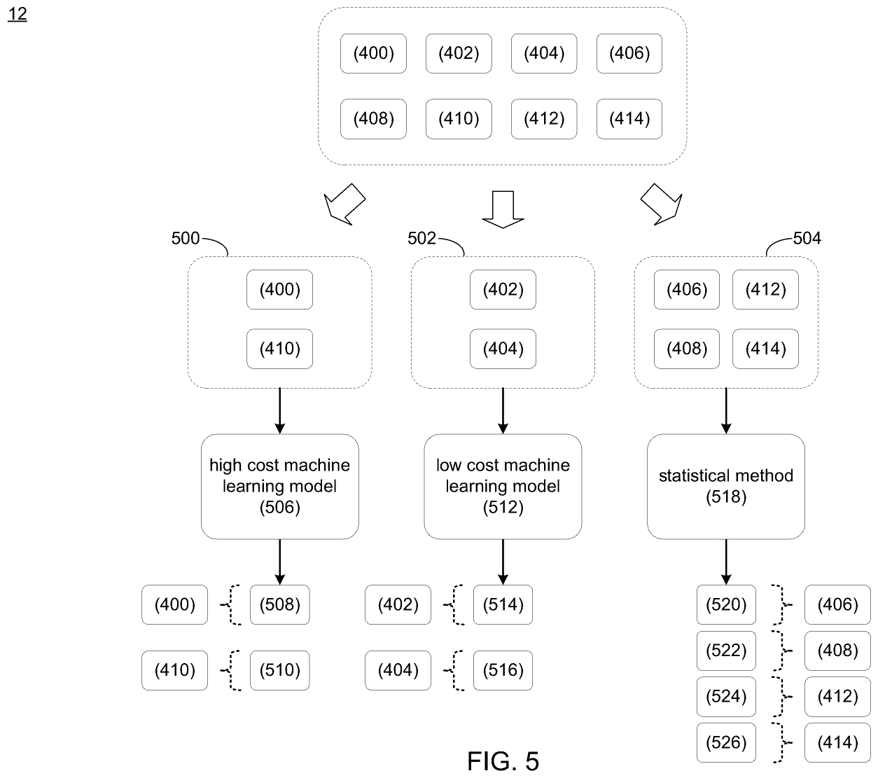

In some implementations, dividing 308 the plurality of storage objects into the active group, the intermediate group, and the dormant group includes defining 310 the active group as a predefined percentage of the plurality of storage objects with a highest respective past activity level. Referring also to the example of FIG. 5, suppose that performance forecasting process 10 determines 300 the respective past activity level for storage objects 400, 402, 404, 406, 408, 410, 412, 414. In this example, suppose that storage objects 400 and 410 are the storage objects with the highest respective past activity level. Further suppose that performance forecasting process 10 is configured to divide 308 the plurality of storage objects into three storage object groups (e.g., storage object group 500 for the plurality of storage objects with a highest respective past activity levels; storage object group 502 for the plurality of storage objects with the next highest past activity levels; and storage object group 504 for the plurality of storage objects with the lowest past activity levels).

In this example, the thresholds between storage object groups 500, 502, 504 may be predefined, user-defined, and/or dynamically-defined by performance forecasting process 10. Suppose that storage object group 500 is designated for 25% of the most active storage objects; storage object group 502 is designated for 25% of the next most active storage objects; and that storage object group 504 is designated for the remaining 50% of the storage objects. In this example, performance forecasting process 10 defines 310 the active group (e.g., storage object group 500) as a predefined percentage of the plurality of storage objects with a highest respective past activity level (e.g., top 25% most active). Performance forecasting process 10 divides 308 storage objects 400 and 410 into storage object group 500; storage objects 402 and 404 into storage object group 502; and storage objects 406, 408, 412, and 414 into storage object group 504. As will be discussed in greater detail below, performance forecasting process 10 uses different IO performance forecasting approaches for each storage object group. In this manner, performance forecasting process 10 enhances the accuracy/computational cost trade-off using storage object groups based on past activity levels for each storage object. While the above examples describe either two or three storage object groups, it will be appreciated that performance forecasting process 10 may divide the storage objects into any number of storage objects groups based upon past activity levels within the scope of the present disclosure. In some implementations, performance forecasting process 10 may divide the storage objects into any number of storage object groups with corresponding performance forecasting approaches (e.g., more active storage object groups have a high performance, but high cost forecasting model while less active storage object groups have a lower performance, but lower cost forecasting approach).

In some implementations, performance forecasting process 10 forecasts 304 input/output (IO) performance data for the plurality of storage objects using particular IO performance forecasting approaches specific to each storage object group. Forecasting IO performance data for the plurality of storage objects may generally include providing a plurality of IO operations and/or IO-related statistics to either a machine learning model or using a statistical method to generate forecast information associated with the storage objects. In this manner, by forecasting IO performance data for a particular storage object, performance forecasting process 10 may utilize the forecasted IO performance to perform some remedial action (e.g., generate an alert for a storage administrator; provide recommendations based on the forecasted IO performance; and/or automatically adjust storage system properties (e.g., add or remove allocated storage space; throttle particular IO requests at specific points in time; etc.)).

In some implementations, performance forecasting process 10 forecasts 304 input/output (IO) performance data for a first storage object group of the plurality of storage object groups using a first machine learning model. A machine learning system or model may generally include an algorithm or combination of algorithms that has been trained to recognize certain types of patterns. For example, machine learning approaches may be generally divided into three categories, depending on the nature of the signal available: supervised learning, unsupervised learning, and reinforcement learning. Supervised learning may include presenting a computing device with example inputs and their desired outputs, given by a “teacher”, where the goal is to learn a general rule that maps inputs to outputs. With unsupervised learning, no labels are given to the learning algorithm, leaving it on its own to find structure in its input. Unsupervised learning can be a goal in itself (discovering hidden patterns in data) or a means towards an end (feature learning). Reinforcement learning may generally include a computing device interacting in a dynamic environment in which it must perform a certain goal (such as driving a vehicle or playing a game against an opponent). As it navigates its problem space, the machine learning model is provided feedback that's analogous to rewards, which it tries to maximize. While three examples of machine learning approaches have been provided, it will be appreciated that other machine learning approaches are possible within the scope of the present disclosure.

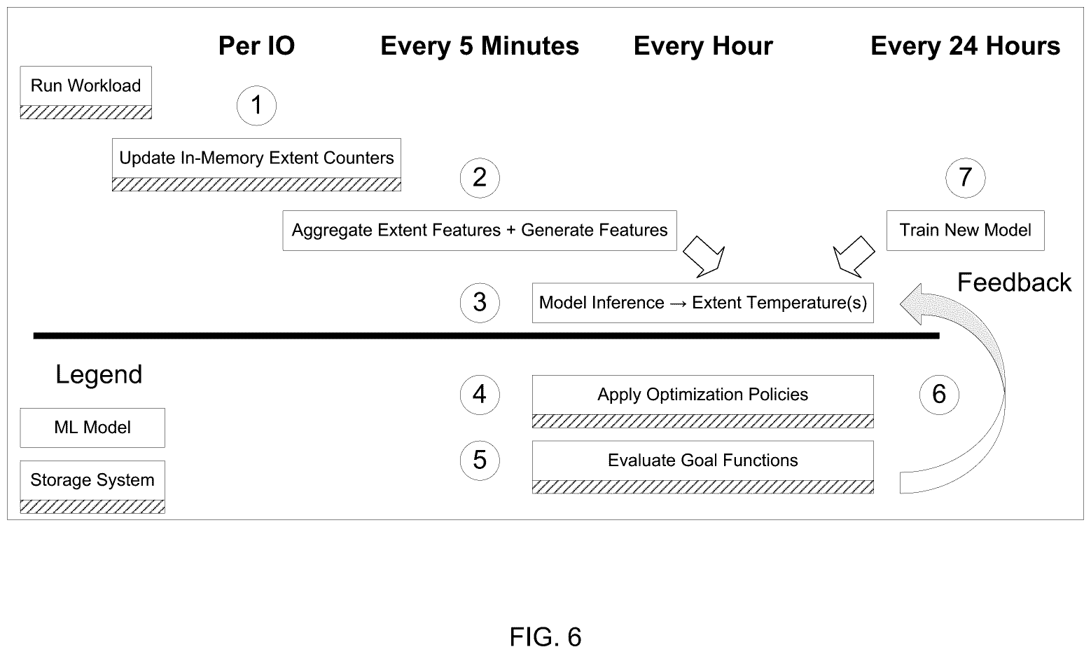

In some implementations, performance forecasting process 10 uses a machine learning model to forecast IO performance data for the plurality of storage objects of the active group. Referring also to FIG. 6 which shows the process of forecasting IO performance data using a machine learning model. For example, at action “1”, the storage system aggregates in memory counters relevant to the features used by the model. In action “2”, at a fixed time interval (e.g., FIG. 6 shows every 5 minutes as an example), the storage system aggregates the memory counters and calculates the relevant features. This can also be triggered if the storage system is running out of room in the memory area dedicated for the counters. In action “3”, the machine learning model is invoked to calculate the extent temperatures for all the extents in the systems, or only for the relevant ones periodically (e.g. every one hour or other defined metric). In action “4”, the storage system uses the updated storage object temperatures to apply or update its optimization policies. For example, in the case of tiering, performance forecasting process 10 may perform storage object promotion or demotion. In the case of caching, performance forecasting process 10 may update or invalidate entries in the cache according the cache replacement policy (e.g. LRU, MRU, etc.). In action “5”, the storage system monitors one or more goal functions (i.e., performance metrics), such as system read or write latency or IOPS, and as a result, may adjust internal parameters, such as cache size, or its API with the machine learning model, for example, to calculate the temperatures more frequently. In action “6”, the storage system may provide feedback to the machine learning model, related either to general settings or specific storage objects. For example, in the case of tiering, when a storage object is demoted, it may experience fewer IO operations because it is now in a slower media capable of serving fewer IOs/second. Without such feedback, the machine learning model may view the extent as having gone cold.

In some implementations, forecasting 304 IO performance data for the first storage object group of the plurality of storage object groups using the first machine learning model includes forecasting 312 IO performance data for storage objects of the active group using a high cost machine learning model. As discussed above, the process for training and using a machine learning model to forecast highly accurate IO performance data requires significant computational resources (i.e., a high cost machine learning model in terms of memory footprint, CPU usage, etc.). As such, performance forecasting process 10 uses a high cost machine learning model to forecast 312 the IO performance data for the most active storage objects. Referring again to FIG. 5, performance forecasting process 10 uses a high cost machine learning model (e.g., high cost machine learning model 506) to forecast 312 IO performance data for storage objects (e.g., IO performance data 508 for storage object 400 and IO performance data 510 for storage object 410). In some implementations, performance forecasting process 10 uses a high cost machine learning model to forecast 312 the exact temperature/IO performance data for the most active storage objects for use cases such as tiering and caching.

In some implementations, performance forecasting process 10 forecasts 31410 performance data for storage objects of the intermediate group using a low cost machine learning model. A low cost machine learning model is a simplified machine learning model with a subset of the features that enables the machine learning model to operate with fewer computing resources. In one example, the simplified machine learning model can achieve e.g., about 70% of the accuracy of the full model (e.g., high cost machine learning model 506) with a memory footprint of about 50 bytes/storage object. In this manner, the low cost machine learning model is any machine learning model with lower accuracy than the high cost machine learning model. Referring again to FIG. 5, performance forecasting process 10 forecasts 314 IO performance data for storage objects using a low cost machine learning model (e.g., low cost machine learning model 512). In this example, low cost machine learning model 512 forecasts 314 IO performance data 514 for storage object 402 and IO performance data 516 for storage object 404). As discussed above, IO performance data 514 and 516 is less accurate than IO performance data 508 and 510 but is more computationally efficient. However, because storage objects 402 and 404 are less active than storage objects 400 and 410, it is less likely that storage objects 402 and 404 will be adjusted. As such, an intermediate accuracy of IO performance data 514 and 516 is acceptable for storage objects 402 and 404.

In some implementations, performance forecasting process 10 forecasts 306 IO performance data for a second storage object group of the plurality of storage object groups using a statistical method. A statistical method includes a non-machine learning model, arithmetic approach for forecasting IO performance. For example, statistical methods generally include equations or arithmetic models that process various values to model IO performance or other trends. Examples of a statistical method include, but are not limited to, a simple moving average (SMA) and exponential moving average (EMA). Simple moving average (SMA) is an arithmetic moving average calculated by adding recent values and then dividing that figure by the number of time periods in the calculation average. Exponential moving average (EMA) is an arithmetic moving average that places more weight on the most recent data. The statistical method may forecast the IO performance of a storage object with minimal computing resources compared to a machine learning model.

In some implementations, forecasting 306 IO performance data for the second storage object group of the plurality of storage object groups using the statistical method includes forecasting 316 IO performance data for storage objects of the dormant group using the statistical method. Referring again to FIG. 5, performance forecasting process 10 forecasts 316 IO performance data for storage objects using a statistical method (e.g., statistical method 518). In this example, statistical method 518 forecasts 316 IO performance data 520 for storage object 406; IO performance data 522 for storage object 408; IO performance data 524 for storage object 412; and IO performance data 526 for storage object 414). As discussed above, IO performance data 520, 522, 524, and 526 are less accurate than IO performance data 508, 510, 514, 516 but are more computationally efficient to generate and maintain. For example, because storage objects 406, 408, 412, and 414 are the least active storage objects, it is less likely that these storage objects will be adjusted. As such, the relatively low accuracy (when compared to the accuracy of high cost machine learning model 506) of IO performance data 520, 522, 524, and 526 is acceptable for storage objects 406, 408, 412, and 414 of dormant group 504.

In some implementations, forecasting 304 IO performance data for the plurality of storage objects may include forecasting 318 IO temperature for the plurality of storage objects. As discussed above, the general level of activity of the storage object may be referred to as the “temperature” of the storage object, where an active storage object is considered “hot” and an inactive object is considered “cold”. The temperature may be defined in terms of the number of IO operations performed by the storage object in a given time unit, the total number of bytes transferred, or some combination of similar metrics.

In some implementations, performance forecasting process 10 may allow for IO performance to be modeled and forecasted over time. In this manner, performance forecasting process 10 may utilize the forecasted IO performance to perform some remedial action (e.g., generate an alert for a storage administrator; provide recommendations based on the forecasted IO performance; and/or automatically adjust storage system properties (e.g., add or remove allocated storage space; throttle particular IO requests at specific points in time; etc.)).

For example, performance forecasting process 10 may compare the forecasted IO performance data to one or more predefined thresholds to determine whether remedial action is warranted. The forecasted IO performance data may provide insights about the storage system's performance in terms of the host activity. For example, performance forecasting process 10 may forecast both the short-term and the long-term analysis of the IO performance data where the short-term analysis may provide the forecast for e.g., the next seven days while the long-term analysis may provide forecast results for e.g., the next year. It will be appreciated the exact scope of the “short-term” and/or the “long-term” may be individually determined for each storage system and/or each forecasting of IO performance data. In some implementations, the combined short-term and long-term forecasted IO performance data may be robust enough to support different platform types and scales to support other metrics (e.g., power consumption, processing power, device longevity, etc.).

In one example implementation comparing forecasting IO performance data using high cost machine learning model 506 (e.g., using 32 MB slices, using a random forest model with ten trees and a max depth of 20) for all storage objects/slices and using high cost machine learning model 506 for only the top 20% most active storage objects, the following results were observed as shown in Table 1 below:

TABLE 1

| | | | Training | Test | Training | Test | Test | |
|---|---|---|---|---|---|---|---|---|
| Model | Training | Test | Time | Time | Size | size | Error | Latency |
| Details | # Slices | # Slices | (sec) | (sec) | (MB) | (MB) | (MAE) | (ms) |
| Full model | 4,000,000 | 1,000,000 | 2530 | 46 | 1,200 | 300 | 0.61 | 0.125 |
| Top 20% | 800,000 | 200,000 | 812 | 31 | 240 | 60 | 0.71 | 0.152 |
| model | | | | | | | | |

As shown in Table 1, performance forecasting process 10 is able to achieve a 5:1 reduction in memory footprint, a 3:1 reduction in training time, and a 33% reduction in test time. With amortized savings over time, the memory enhancement should be even better, as several machine learning models have a fixed memory and time overhead when launched. In this example, the tradeoff in accuracy for these savings was increasing the model error by about 15% and the projected latency by about 20%. Accordingly, performance forecasting process 10 allows for improved memory management for forecasting IO performance data for storage objects within a storage system based upon, at least in part, each storage object's past activity level.

### General:

As will be appreciated by one skilled in the art, the present disclosure may be embodied as a method, a system, or a computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. The computer-usable or computer-readable medium may also be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present disclosure may be written in an object oriented programming language such as Java, Smalltalk, C++ or the like. However, the computer program code for carrying out operations of the present disclosure may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network/a wide area network/the Internet (e.g., network 14).

The present disclosure is described with reference to flowchart illustrations and/or block diagrams of methods, apparatus (systems) and computer program products according to implementations of the disclosure. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer/special purpose computer/other programmable data processing apparatus, such that the instructions, which execute via the processor of the computer or other programmable data processing apparatus, create means for implementing the functions/acts specified in the flowchart and/or block diagram block or blocks.

These computer program instructions may also be stored in a computer-readable memory that may direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowcharts and block diagrams in the figures may illustrate the architecture, functionality, and operation of possible implementations of systems, methods and computer program products according to various implementations of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The terminology used herein is for the purpose of describing particular implementations only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various implementations with various modifications as are suited to the particular use contemplated.

A number of implementations have been described. Having thus described the disclosure of the present application in detail and by reference to implementations thereof, it will be apparent that modifications and variations are possible without departing from the scope of the disclosure defined in the appended claims.

What is claimed is:

1. A computer-implemented method, executed on a computing device, comprising:
determining a respective past activity level associated with a plurality of storage objects;
dividing the plurality of storage objects into a plurality of storage object groups based upon, at least in part, the respective past activity level associated with the plurality of storage objects;
forecasting input/output (IO) performance data for a first storage object group of the plurality of storage object groups using a first machine learning model; and
forecasting IO performance data for a second storage object group of the plurality of storage object groups using a statistical method.

2. The computer-implemented method of claim 1, wherein dividing the plurality of storage objects into a plurality of storage object groups based upon, at least in part, the respective past activity level associated with each of the plurality of storage objects includes dividing the plurality of storage objects into an active group, an intermediate group, and a dormant group.

3. The computer-implemented method of claim 2, wherein forecasting IO performance data for the first storage object group of the plurality of storage object groups using the first machine learning model includes forecasting IO performance data for storage objects of the active group using a high cost machine learning model.

4. The computer-implemented method of claim 2, wherein forecasting IO performance data for the second storage object group of the plurality of storage object groups using the statistical method includes forecasting IO performance data for storage objects of the dormant group using the statistical method.

5. The computer-implemented method of claim 2, further comprising:
forecasting IO performance data for storage objects of the intermediate group using a low cost machine learning model.

6. The computer-implemented method of claim 2, wherein dividing the plurality of storage objects into the active group, the intermediate group, and the dormant group includes defining the active group as a predefined percentage of the plurality of storage objects with a highest respective past activity level.

7. The computer-implemented method of claim 1, wherein forecasting IO performance data includes forecasting IO temperature for the plurality of storage objects.

8. A computer program product residing on a non-transitory computer readable medium having a plurality of instructions stored thereon which, when executed by a processor, cause the processor to perform operations comprising:
determining a respective past activity level associated with a plurality of storage objects;
dividing the plurality of storage objects into a plurality of storage object groups based upon, at least in part, the respective past activity level associated with the plurality of storage objects;
forecasting input/output (IO) performance data for a first storage object group of the plurality of storage object groups using a first machine learning model; and
forecasting IO performance data for a second storage object group of the plurality of storage object groups using a statistical method.

9. The computer program product of claim 8, wherein dividing the plurality of storage objects into a plurality of storage object groups based upon, at least in part, the respective past activity level associated with each of the plurality of storage objects includes dividing the plurality of storage objects into an active group, an intermediate group, and a dormant group.

10. The computer program product of claim 9, wherein forecasting IO performance data for the first storage object group of the plurality of storage object groups using the first machine learning model includes forecasting IO performance data for storage objects of the active group using a high cost machine learning model.

11. The computer program product of claim 9, wherein forecasting IO performance data for the second storage object group of the plurality of storage object groups using the statistical method includes forecasting IO performance data for storage objects of the dormant group using the statistical method.

12. The computer program product of claim 9, wherein the operations further comprise:
forecasting IO performance data for storage objects of the intermediate group using a low cost machine learning model.

13. The computer program product of claim 9, wherein dividing the plurality of storage objects into the active group, the intermediate group, and the dormant group includes defining the active group as a predefined percentage of the plurality of storage objects with a highest respective past activity level.

14. The computer program product of claim 8, wherein forecasting IO performance data includes forecasting IO temperature for the plurality of storage objects.

15. A computing system comprising:
a memory; and
a processor configured to determining a respective past activity level associated with a plurality of storage objects, wherein to processor is further configured to divide the plurality of storage objects into a plurality of storage object groups based upon, at least in part, the respective past activity level associated with the plurality of storage objects, wherein to processor is further configured to forecast input/output (IO) performance data for a first storage object group of the plurality of storage object groups using a first machine learning model, and wherein to processor is further configured to forecast IO performance data for a second storage object group of the plurality of storage object groups using a statistical method.

16. The computing system of claim 15, wherein dividing the plurality of storage objects into a plurality of storage object groups based upon, at least in part, the respective past activity level associated with each of the plurality of storage objects includes dividing the plurality of storage objects into an active group, an intermediate group, and a dormant group.

17. The computing system of claim 16, wherein forecasting IO performance data for the first storage object group of the plurality of storage object groups using the first machine learning model includes forecasting IO performance data for storage objects of the active group using a high cost machine learning model.

18. The computing system of claim 16, wherein forecasting IO performance data for the second storage object group of the plurality of storage object groups using the statistical method includes forecasting IO performance data for storage objects of the dormant group using the statistical method.

19. The computing system of claim 17, wherein the processor is further configured to:
forecast IO performance data for storage objects of the intermediate group using a low cost machine learning model.

20. The computing system of claim 15, wherein dividing the plurality of storage objects into an active group, an intermediate group, and a dormant group includes defining the active group as a predefined percentage of the plurality of storage objects with a highest respective past activity level.
